(19) United States
(12) Patent Application Publication
(10) Pub. No.: US 2006/0079977 A1
(43) Pub. Date: Apr. 13, 2006

(54) Information processing system that synchronizes content data

(76) Inventors: Michio Nagai, Akiruno-shi (JP); Takafumi Onishi, Chofu-shi (JP)

Correspondence Address: STRAUB & POKOTYLO, 620 TINTON AVENUE, BLDG. B, 2ND FLOOR, TINTON FALLS, NJ, 07724, US

(21) Appl. No.: 11/246,040

(22) Filed: Oct. 7, 2005

(30) Foreign Application Priority Data
Oct. 12, 2004 (JP) 2004-297964

(51) Int. Cl. G06F 17/00

(52) U.S. Cl. 700/94

(57) ABSTRACT

The present invention provides an information processing system wherein if external equipment (PC) 1 transfers music and image data to a portable device (PD) 2 capable of executing a synchronizing process, synchronization is carried out by extracting music data, image data, and template data used in a project file, determining whether or not the data has been transferred or updated, and transferring required data or the like depending on the determination.

### CROSS-REFERENCE TO RELATED APPLICATIONS

This application is based upon and claims the benefit of priority from prior Japanese Patent Application No. 2004-297964, filed Oct. 12, 2004, the entire contents of which are incorporated herein by reference.

### BACKGROUND OF THE INVENTION

1. Field of the Invention

The present invention relates to an information processing system that synchronizes content data between an information processing apparatus and a portable terminal.

2. Description of the Related Art

In recent years, a portable audio reproducing device (portable device) has been known to which music or an image loaded into a personal computer (PC) from CD or DVD or through network communication is transferred and which then reproduces the music or image. The audio reproducing device is provided with a storage device such as a hard disk and thus has a larger storage capacity than conventional detachable storage media. The audio reproducing device has a function for storing and reproducing not only music data but also image data.

Music data from an external apparatus such as a server or PC must be transferred to the audio reproducing device. For example, such a communication system as disclosed in Jpn. Pat. Appln. No. 2001-093226 must be used to transfer music data from an audio server to the audio reproducing device using a transfer list.

Such a transfer method as disclosed in Jpn. Pat. Appln. No. 2001-093226 is suitable for transferring data that allows music or an image to be unitarily reproduced. On the other hand, a project file allows music and an image to be linked together for reproduction. This file has a combination of link information on a music file, link information on an image file, and template selection information required to specify an effect for reproduction. Consequently, the project file cannot be unitarily reproduced. If such data is transferred from a PC to portable equipment, these data must be synchronized with one another so as to be correctly linked together.

Accordingly, the portable equipment cannot correctly reproduce the project file simply by creating a transfer list as disclosed in Jpn. Pat. Appln. No. 2001-093226. Thus, some methods combine these data into one folder to write all the data to a hard disk (memory) in the portable equipment. However, duplicate data may be written to the hard disk, thus wasting the storage capacity.

### BRIEF SUMMARY OF THE INVENTION

The present invention is an information processing system that executes a process of appropriately synchronizing content files when transferring content data between an external apparatus that supplies music data or image data and a portable device.

The present invention provides an information processing system which synchronizes plural types of content data stored in each of an information processing apparatus and a portable terminal, the system comprising first synchronizing means for executing a synchronizing process on independently reproduced first content data, second synchronizing means for executing a synchronizing process on second content data reproduced with reference to other material content, and third synchronizing means for executing a synchronizing process on the material content.

### BRIEF DESCRIPTION OF THE SEVERAL VIEWS OF THE DRAWING

FIG. 1 is a diagram showing the configuration of an information processing system according to an embodiment of the present invention;

FIG. 2 is a diagram conceptually showing storage areas on an HDD in a PC main body and on an HDD in a PD, the PC main body and PD being shown in FIG. 1;

FIG. 3 is a diagram showing the data structures of PCSyncDB and PDSyncDB;

FIGS. 4A and 4B are diagrams showing tables in MasterDB;

FIGS. 5A, 5B, 5C, 5D, 5E, 5F, and 5G are diagrams continued from FIGS. 4A and 4B and showing tables in MasterDB;

FIG. 6 is a flowchart illustrating a process of synchronizing content;

FIG. 7 is a flowchart illustrating a process of creating and updating a project file;

FIG. 8 is a diagram showing an example of a project file (remix file);

FIG. 9 is a flowchart illustrating a content synchronizing process;

FIG. 10 is a flowchart useful in describing “transfer to PD” in FIG. 9;

FIG. 11 is a flowchart useful in describing “deletion from PD 2” in FIG. 9;

FIG. 12 is a flowchart useful in describing a “project transfer” process in FIG. 9; and

FIG. 13 is a flowchart useful in describing a “project deletion” process in FIG. 9.

### DETAILED DESCRIPTION OF THE PREFERRED EMBODIMENT

An embodiment of the present invention will be described below in detail with reference to the drawings.

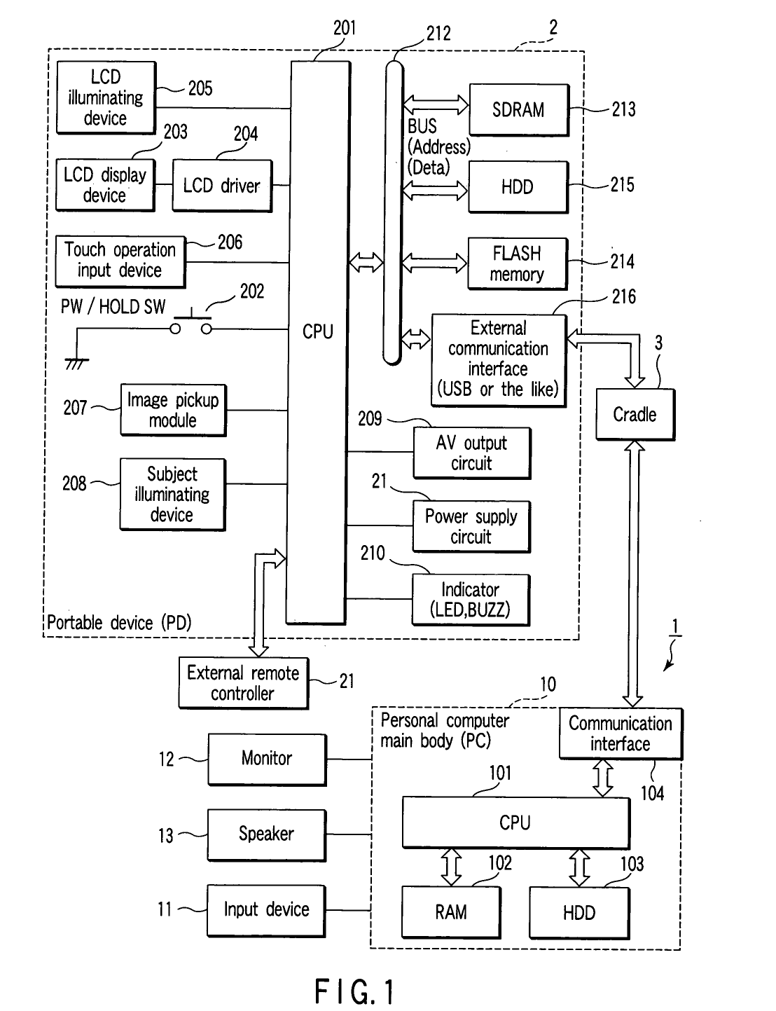

FIG. 1 is a diagram showing the configuration of an information processing system according to an embodiment of the present invention. The information processing system has a personal computer (PC) 1 that is an information processing apparatus storing content data and a portable device (PD) 2 that is portable equipment capable of acquiring and processing content data transmitted by PC 1.

In this information processing system, PD 2 has a remix mode. The remix mode is a contents reproduction mode in which while a music piece is being played, specified images are consecutively displayed using specified timings and a specified display method (including effects produced when the images are switched) (reproduction of contents in the remix mode will be referred to as “remix reproduction” below). The present embodiment uses template data containing specified information indicating how images are displayed during remix reproduction, what timings are used to display the images during remix reproduction, and what effects are used in switching the images during remix reproduction. This enables the user to easily set remix reproduction. The user then stores information required for remix reproduction in a project file; the information indicates which images are displayed, which music piece is used, and which template data is used. Accordingly, remix reproduction is carried out by executing the project file. In the embodiment below, description will be given of a process of executing synchronization on a project file. In PD 2 in this system which has a hard disk, stored content are managed in PC 1 using a method called a synchronizing process. The synchronizing process involves connecting PD 2 and PC 1 together and executing a process such that the content (content data) stored in PD 2 are equal to part or all of the content stored in PC 1. In the present embodiment, if a synchronizing process is executed which involves transmitting all the content not stored in PD 2 from PC 1 to PD 2 at a time or any item has been changed in PD 2, a synchronizing process is executed in which PC 1 reads the content PD 2, extracts the changed item on the basis of comparison, modifies the changed item, and transmits all the content to PD 2.

PC 1 is composed of a PC main body 10, an input device 11 such as a keyboard and a mouse, and a monitor 12 and a speaker 13 which serve as an output device. The PC main body 10 comprises CPU 101 serving as a control section, RAM 102 utilized as a work area for CPU 101, a hard disk drive (HDD) 103 in which control programs and content data are stored, and a communication interface 104 such as a serial interface or a USB (Universal Serial Bus) interface which is required to communicate with external equipment. The content data stored in HDD 103 include image data, video data, music data, text data, template data, and a project file.

The contents data stored in HDD 103 can be displayed on the monitor 12 as a list or thumbnails. Further, a synchronization checkbox is provided for each of the contents during the list or thumbnail display. The user can controllably indicate whether or not to synchronize desired contents by using the input device 11 to perform input operations to turn on or off the checkboxes.

PD 2 comprises CPU 201, PWSW 202, an LCD display device 203, an LCD driver 204, an LCD illuminating device 205, a touch operation input device 206, an image pickup module 207, a subject illuminating device 208, an AV output circuit 209, an indicator 210, a power supply circuit 211, BUS 212, SDRAM 213, a FLASH memory 214, HDD 215, and an external communication interface 216. Here, CPU 201 is a control section that controls each section of PD 2. PWSW 202 is a power supply switch that starts or stops the operation of PD 2 in accordance with a user's operation.

The LCD display device 203 is a color liquid crystal display device used to display content such as images or videos. The LCD driver 204 controls the LCD display device 203. The LCD illuminating device 205 is a backlight that illuminates the LCD display device 203. The touch operation input device 206 is disposed on a display screen of the LCD display device 203 to sense the user's finger or a position touched by a pen. A touch panel is composed of the LCD display device 203, the LCD driver 204, the LCD illuminating device 205, and the touch operation inputting device 206. The touch panel enables operation keys to be virtually implemented. Accordingly, PD 2 is not provided with the operation keys other than PWSW 202.

The image pickup module 207 is a camera used to take still images or motion pictures. The subject illuminating device 208 uses a small-sized light source such as LED to illuminate a subject. The AV output circuit 209 supplies video and audio signals to an external apparatus such as a television. The indicator 210 is LED or a buzzer that presents the state of PD 2 to the user using light or sound. The power supply circuit 211 supplies power required for the operation of each section of PD 2 using a built-in battery or an external AC adapter (not shown).

BUS 212 is a transmission path that connects CPU 201, SDRAM 213, the FLASH memory 214, HDD 215, and the external communication interface 216 together to transmit addresses and data. SDRAM 213 is a memory utilized as a work area for CPU 201. The FLASH memory 214 stores various data such as date data, a part of a control program, control parameters, or the like in a nonvolatile manner. HDD 215 is a hard disk drive to which a control program or content data acquired from PC 1 is saved. The external communication interface 216 is a communication interface such as a USB interface.

The external communication interface 216 may be connected directly to the communication interface 104 of the PC main body 10 via a cable. Alternatively, a cradle 3 may be interposed between the external communication interface 216 and the communication interface 104 of the PC main body 10 for data communication as shown in FIG. 1. Here, the cradle 3 is a stand-like expansion equipment on which PD 2 is installed and comprises a function for mediating in data communication and a function for charging PD 2.

An external remote controller 21 can be connected to CPU 201 of PD 2 via a remote controller terminal (not shown). Moreover, a headphone can be connected to CPU 201 via a headphone terminal. The external remote controller 21 may be provided with a connection portion used to connect the external remote controller 21 to the remote controller terminal of PD 2 or the headphone terminal. Alternatively, the headphone may be connected to a headphone terminal provided in the external remote controller 21.

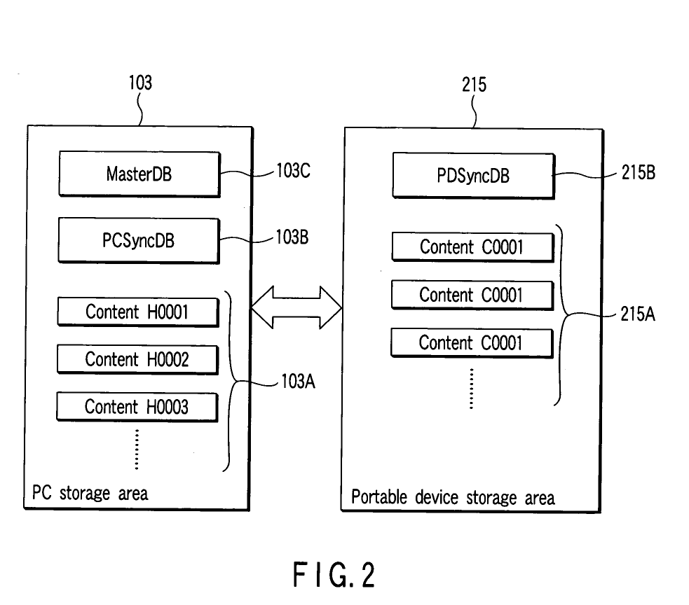

FIG. 2 is a conceptual drawing of storage areas in HDD 103 in the PC main body 10 and in HDD 215 in PD 2. Here, description will be given of the storage area in HDD 103 in the PC main body 10 as an example. However, data may be written in the storage area of another storage media, for example, DVD.

As shown in the figure, a plurality of content data (a content H0001, a content H0002, a content H0003, . . . ) 103A are stored in HDD 103 in the PC main body 10. Further, HDD 103 stores a database PCSyncDB (DataBase; referred to as DB below) 103B in which various information indicative of the state of the synchronization between PC 1 and PD 2 is registered. HDD 103 also stores a database MasterDB 103C in which information on the content is registered. In this case, the content of PCSyncDB 103B are updated in response to a certain operation performed on the content data 103A by PC 1. FIG. 1 shows only one PD 2. However, a plurality of PDs may be simultaneously or individually connected to PC 1. Thus, information required to manage each PD 2 is registered in MasterDB 103C.

Further, a plurality of content data (a content C0001, a content C0002, a content C0003, . . . ) acquired from PC 1 are stored in HDD 215 in PD 2. HDD 215 also stores a database PDSyncDB 215B similar to PCSyncDB 103B in PC 1. Although described below in detail, the content of PDSyncDB 215B are updated in response to a certain operation performed on the content data 215A in PD 2. During synchronization of data with PC 1, the content of PDSyncDB 215B are sent to PC 1, and on the basis of these content, the content of PCSyncDB 103B in PC are updated. PD 2 then receives the content of PCSyncDB 103B to update the content of PDSyncDB 215B.

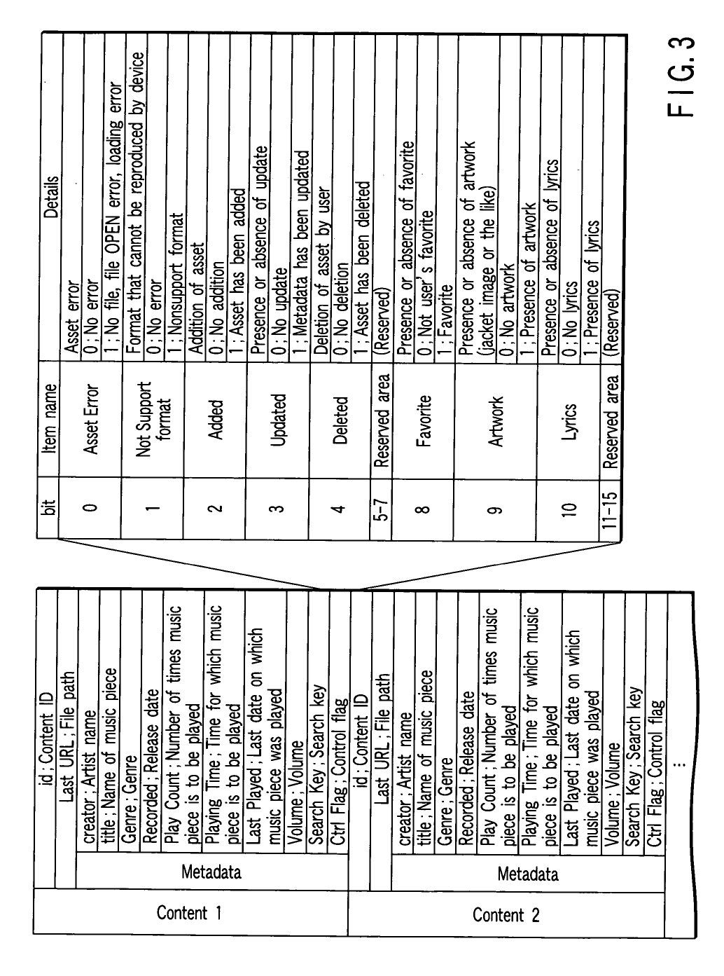

FIG. 3 shows the data structures of PCSyncDB 103B and PDSyncDB 215B. Actually, an MPV (Multi Photo/Video) format file is saved which specifies XML metadata used to describe the content of PCSyncDB 103B and PDSyncDB 215B. A file is created for each type of content such as images or music. In the example described below, the content type is music data.

For each content, a content ID (id), a file path (Last URL), and metadata are registered in PCSyncDB 103B (or PDSyncDB 215B); the content ID is used as a header and identifies the content and the file path indicates the position at which the content is stored in HDD 103 (or HDD 215).

The metadata contains data such as an artist name (Creator), a song title (Title), a genre (Genre), a release date (Recorded), the number of times the song is played (PlayCount), the time for which the song is played (PlayingTime), the last date on which the song is played (LastPlayed), the volume (Volume), a search key (SearchKey), and a control flag (CtrlFlag). Here, the search key (SearchKey) is a keyword that a user can arbitrarily set in order to facilitate a search for a content.

Further, the control flag (CtrlFlag) consists of 16 bits in total. Bits 0 and 1 are assigned to an asset error (Asset Error) and a nonsupport format (Not Support format), respectively. Bits 2, 3, and 4 indicate addition of an asset (Added), update (Updated), and deletion (canceled). Bits 5 to 7 constitute a reserved area. Bits 8, 9, and 10 are assigned to a favorite (Favorite), artwork (Artwork), and lyrics (Lyrics). Bits 11 to 15 constitute a reserved area.

The asset error (Asset Error) in bit 0 is a flag indicating whether or not an error is occurring in an asset (a content or a combination of a content and another content [for example, a combination of a music content and an image content]).

The unsupported format (Not Support format) in bit 1 indicates whether or not the asset has a format that cannot be reproduced by PD 2.

The addition of an asset (Added) in bit 2 indicates whether or not an asset has been added.

The update (Updated) in bit 3 indicates whether or not a certain update has been carried out on the metadata on the content.

The deletion (Deleted) in bit 4 indicates whether or not a user's operation has deleted the asset.

The favorite (Favorite) in bit 8 indicates whether or not the user has specified a song as his or her favorite.

The artwork (Artwork) in bit 9 indicates whether or not artwork such as a jacket image is present.

The lyrics (Lyrics) in bit 10 indicates whether or not lyrics data is present.

As previously described, PCSyncDB 103B and PDSyncDB 215B are created for each content type. Nonetheless, a plurality of databases may be created for contents of the same type. For example, the first 1000 contents may be registered in one database, and the 1001st content and some following contents may be registered in another database.

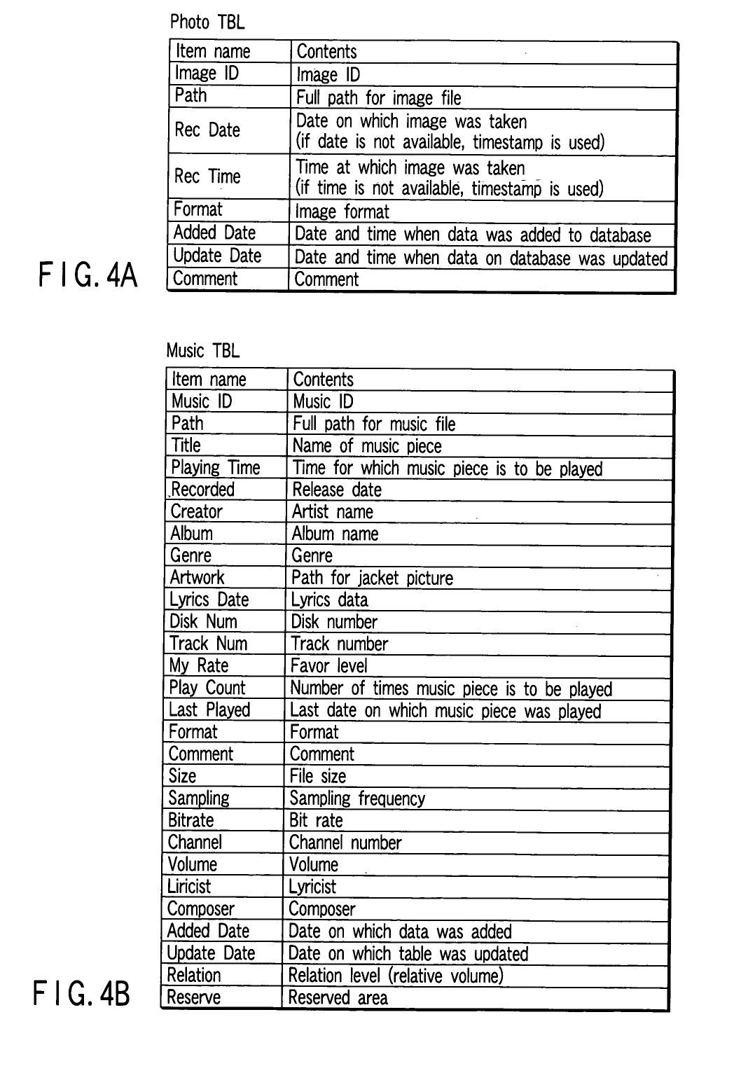

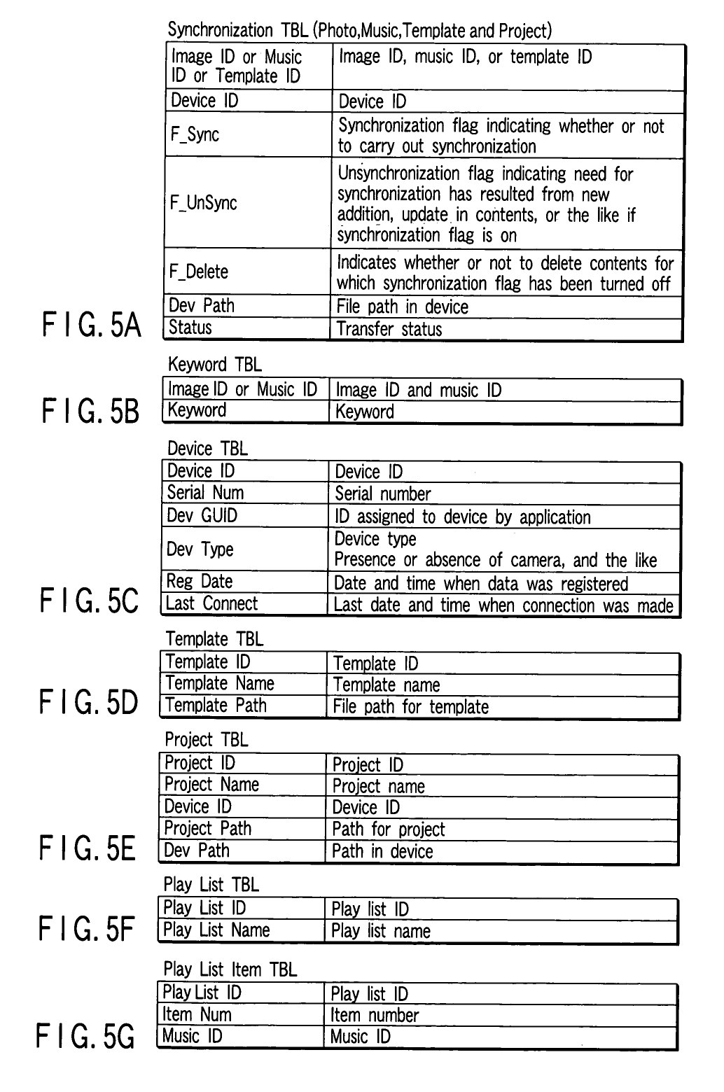

On the other hand, MasterDB 103C provided only in PC 1 is a relational database represented by nine tables, PhotoTBL 103C1, MusicTBL 103C2, SynchronizationTBL 103C3, KeywordTBL 103C4, DeviceTBL 103C5, TemplateTBL 103C6, ProjectTBL 103C7, PlayListTBL 103C8, and PlayListItemTBL 103C9, as shown in FIGS. 4A and 4B and FIGS. 5A to 5G.

PhotoTBL 103C1 is a table used to manage image content. Eight items, ImageID, Path, RecDate, RecTime, Format, AddedDate, UpdateDate, and Comment are defined in PhotoTBL 103C1. Here, ImageID indicates an image ID that identifies an image content. Path indicates a full path for an image file. RecDate indicates the date on which the image was taken (if the date data is not available, a timestamp is used). RecTime indicates the time at which the image was taken (if the time data is not available, a timestamp is used). Format indicates an image format. AddedDate indicates the date and time when data was added to the database. UpdateDate indicates the date and time when data on the database was changed. Comment indicates an arbitrary comment.

MusicTBL 103C2 is a table used to manage music content. The following twenty eight items are defined in MusicTBL 103C2: MusicID, Path, Title, PlayingTime, Recorded, Creator, Album, Genre, Artwork, LyricsData, DiskNum, TrackNum, MyRate, PlayCount, LastPlayed, Format, Comment, Size, Sampling, Bitrate, Channel, Volume, Lyricist, Composer, AddedDate, UpdateDate, Relation, and Reserve.

MusicID indicates a music ID that identifies a music content. Path indicates a full path for a music file. Title indicates the title of a music piece. PlayingTime indicates the time for which the music piece is to be played. Recorded indicates the date on which a CD album containing the music piece will be released. Creator, Album, and Genre indicate an artist name, an album name, and a genre, respectively. Artwork indicates a path for a jacket picture. LyricsData, DiskNum, and TrackNum indicate lyrics data, a disk number, and a track number, respectively. MyRate indicates the user's favor level. PlayCount indicates the number of times that the music piece is to be played. LastPlayed indicates the last date on which the music piece was played. Format, Comment, Size indicate a format, a comment, and a file size, respectively. Sampling, Bitrate, and Channel indicate a sampling frequency, a bit rate, and a channel number, respectively. Volume, Lyricist, and Composer indicate a volume, a lyricist, and a composer. AddedDate indicates the date on which data was added to the table. UpdateDate indicates the date on which the table was updated. Relation indicates a relation level (relative volume). Reserve is a reserved area.

SynchronizationTBL 103C3 is a database used to manage synchronization of image content, music content, or templates. SynchronizationTBL 103C3 is created for each content type. Seven items, ImageID or MusicID or TemplateID, DeviceID, F_Sync, F_Unsync, F_Delete, DevPath, and Status are defined in SynchronizationTBL 103C3. Here, ImageID or MusicID or TemplateID indicates an image ID, a music ID, or a template ID. DeviceID is device ID that identifies PD 2. F_Sync indicates a synchronization flag showing whether or not to carry out synchronization. F_Unsync indicates a nonsynchronization flag showing whether or not the need has arisen to carry out synchronization as a result of a new addition, an update in content, or the like if shows an unsynchronization flag indicating whether or not an update in contents or the like has resulted in the need for synchronization. F_Delete indicates whether or not to delete the contents. If the synchronization flag (F_Sync) is changed from “1” to “0” an instruction on deletion is given. DevPath indicates a file path in PD 2. Status indicates a transfer status.

F_Sync operates in unison with the turn-on and -off of the synchronization checkboxes.

KeywordTBL 103C4 is a table used to manage keywords. Two items, ImageID or MusicID and Keyword are defined in KeywordTBL 103C4. ImageID or MusicID indicates an image ID or a music ID. Keyword indicates a keyword.

DeviceTBL 103C5 is a table used to manage PD 2. Six items, DeviceID, SerialNumber, DevGUID, Devtype, RegDate, and LastConnect are defined in DeviceTBL 103C5. Here, DeviceID and SerialNumber indicate a device ID and a serial number, respectively. DevGUID indicates ID assigned to the device by an application. DevType indicates a device type such as the presence or absence of a camera. RegDate indicates the date on which the data was registered. LastConnect indicates the last date and time when connection to the device was made.

TemplateTBL 103C6 is a table used to manage templates. Three items, TemplateID, Template Name, and TemplatePath are defined in TemplateTBL 103C6. Here, TemplateID, TemplateName, and TemplatePath indicate a template ID, the name of a template, and a file path for the template, respectively.

ProjectTBL 103C7 is a table used to manage projects. The project is a description of results of what is called an authoring operation in which the user arbitrarily combines content together and sets a reproduction timing for each content or the like as in the slide display. Five items, ProjectID, ProjectName, DeviceID, ProjectPath, and DevPath are defined in ProjectTBL 103C7. Here, ProjectID indicates a project ID that identifies a project file. ProjectName and DeviceID indicate the name of a project and a device ID, respectively. ProjectPath and DevPath indicate a file path for the project and a file path in PD 2, respectively.

PlayListTBL 103C8 is a table used to manage play lists. The play list is a description of the order in which a plurality of content are reproduced. Two items, PlayListID and PlayListName are defined in PlayListTBL 103C8. Here, PlayListID indicates a play list ID that identifies a play list. PlayListName indicates the name of the play list.

PlayListItemTBL 103C9 is a table used to manage the content of a play list. Three items, PlayListID, ItemNum, and MusicID are defined in PlayListItemTBL 103C9. Here, PlaylistID, ItemNum, and MusicID indicate a play list ID, an item number, and a music ID, respectively.

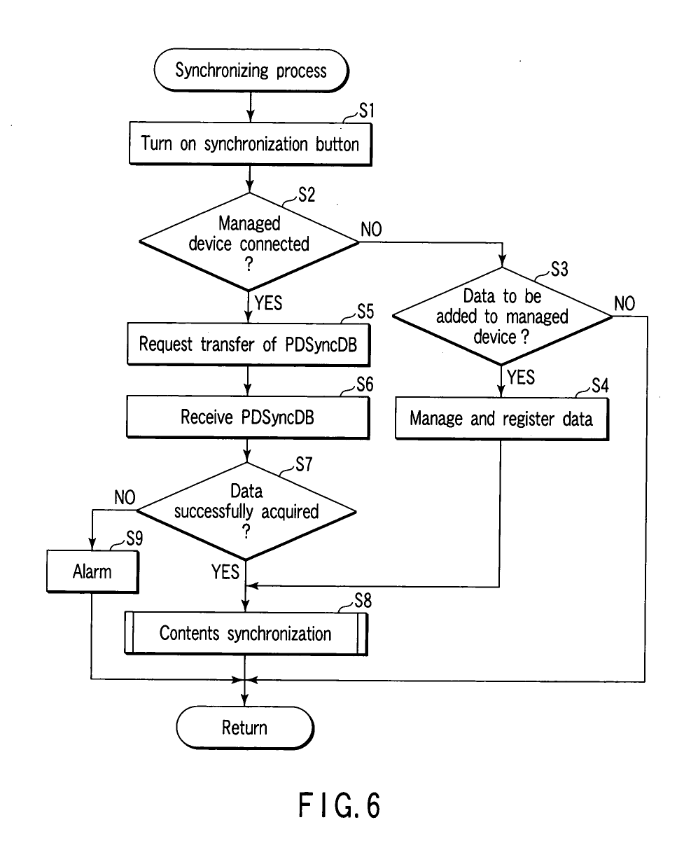

Now, with reference to the flowchart shown in FIG. 6, description will be given of a process of synchronizing content.

Before starting a synchronizing process, PD 2 is installed in the cradle, connected to the communication interface 104 of the PC main body 10. The external communication interface 216 is inserted into the cradle. This installation connects PC 1 to PD 2. The communication interface 104 may be connected directly to the external communication interface 216 via a cable without using the cradle.

First, a content synchronizing process is selected from a menu or the like. Then, a DIALOG used to start a synchronizing process is displayed on the display screen of PC 1. Turning on this button in DIALOG starts a synchronizing process (step S1).

First, the system determines whether or not a managed device (already managed and registered PD) has been connected to PD (step S2). If the system determines that the managed device PD2 has not been connected to the PC (if NO), the system then determines whether the device PD2 should be added to the PC (or should be registered in and managed by the PC). If the device PD2 has been already registered (if NO), the process returns. If the device PD2 has not been registered (if YES), it is registered in the PC (Step S4). Then, the process shifts to step S8, described below, to execute a content synchronizing process. On the other hand, if the system determines that the connected PD 2 is a managed device (YES), PC 1 issues a request for transfer of PDSyncDB to PD 2 (step S5). PC 1 requests PDSyncDB so that if PDSyncDB to be acquired is different from the one previously written to PD 2, the corresponding items are reflected in MasterDB. In response to the request, PDSyncDB is transmitted to PC 1, which receives the database. PC 1 stores PDSyncDB as a temporary file (step S6). Once the reception is completed, the system determines whether or not PC 1 has successfully acquired the data (step S7). When the system determines that PC 1 has successfully acquired the data (YES), PC 1 synthesizes the content (step S8) and the process returns. On the other hand, if PC 1 has not successfully acquired the data (NO), PC 1 issues an alarm indicating this (step S9) and the process returns. In addition to the alarm, it is possible to ask whether to execute a synchronizing process again.

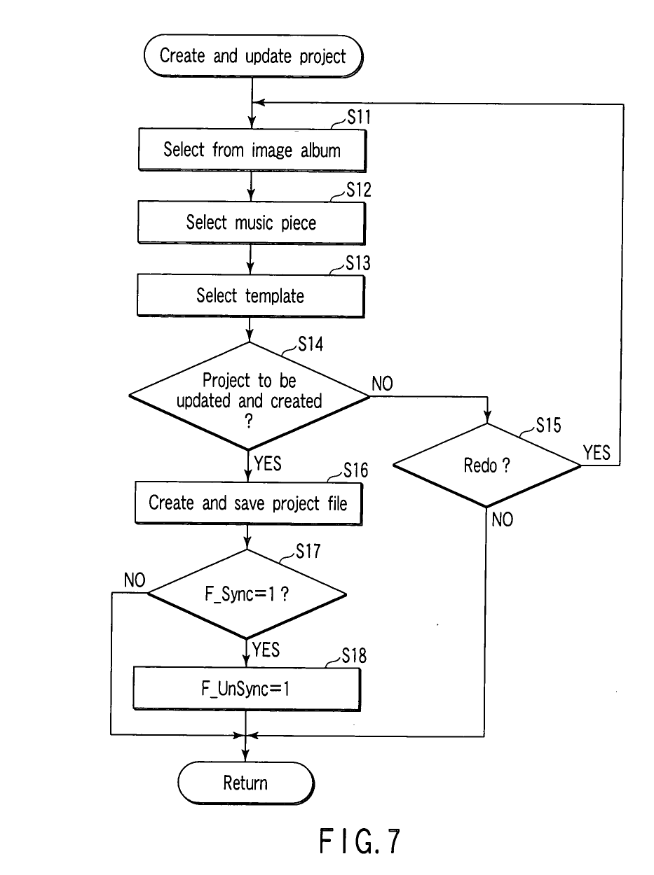

Now, with reference to the flowchart shown in FIG. 7, description will be given of a process of creating and updating a project file. In connection with the creation and update of a project file, the screen of PC 1 is divided into a template area in which a project file is actually created and changed, an image selection area, a plurality of index images (image album) are displayed, a music selection area consisting of a plurality of music pieces, and a template selection area consisting of a plurality of templates. These areas are displayed as respective tables. A desired template, a desired music piece, and a desired image is selected from these tables and created.

First, the selected index image is placed in the template area and divided into a plurality of image frames (step S11). Then, the desired music piece is selected from the music selection area (step S12). Moreover, a template is selected from the template selection area (step S13).

Subsequently, the system determines whether or not to create and update a project file using the selected image, music piece, and template (step S14). If creation and update are not to be carried out (NO), the system determines whether or not to make selection again (step S15). If the system determines that selection should be made again (YES), the process returns to step S11 to make selection again. On the other hand, the system does not determine that selection should be made again (NO), the process returns.

Further, if the system determines in step S14 that a creating or updating operation is to be performed, a project file is created using the selected image, music piece, and template and is saved (step S16). Creation of a project file means description of selected music contents, image contents, templates, template icon information, and the like in an MPV file. The template is a file described in an SVG (Scalable Vector Graphics) language. Display effects (zoom-in, zoom-out, cross fade, movement, or the like) for the image contents are described in the SVG file in association with a time axis. A plurality of templates are provided which are designed for the respective themes beforehand. To actually execute the project file for remix reproduction, the file name for the selected image contents is changed to the corresponding one used in the SVG file. The project file is thus copied to the same directory as that to which the SVG file belongs. Subsequently, a process is executed in accordance with the description in the SVG file to provide the selected images with the display effects in real time. The images are then displayed on the LCD display device 203.

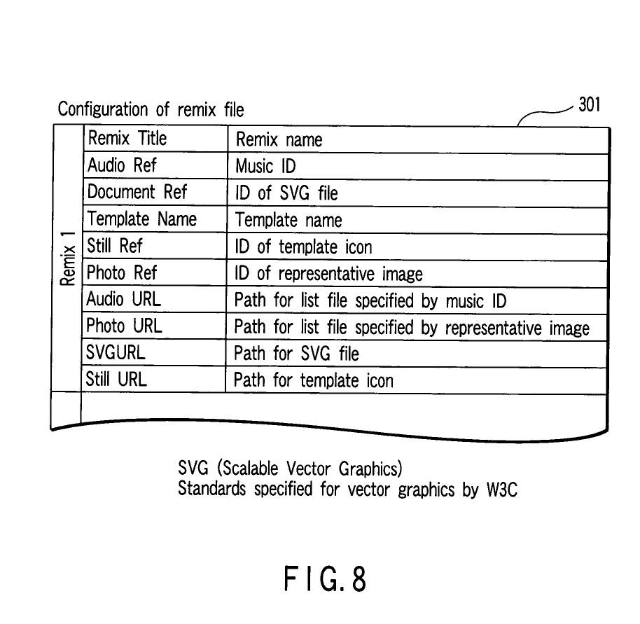

FIG. 8 shows an example of project file (remix file).

A file 301 is provided with items including Remixtitle: a remix title, AudioRef: a music ID, DocumentRef: ID of an SVG file, TemplateName: a template name; StillRef: ID of a template icon, PhotoRef: ID of a representative image, AudioURL: a path for a list file specified by the music ID, PhotoURL: a path for a list specified by the representative image, SVGURL: a path for an SVG file, and StillURL: a path for a template icon.

Then, in creating and updating a project file, the system determines whether or not “1” is set for content synchronization (F_Sync=1?) (step S17). If the setting is made so as to carry out synchronization (YES), F_UnSync=1 is set to set the need for synchronization. The process then returns (step S18). On the other hand, if the system does not determine in step S17 that “1” is set for content synchronization (NO), the process returns.

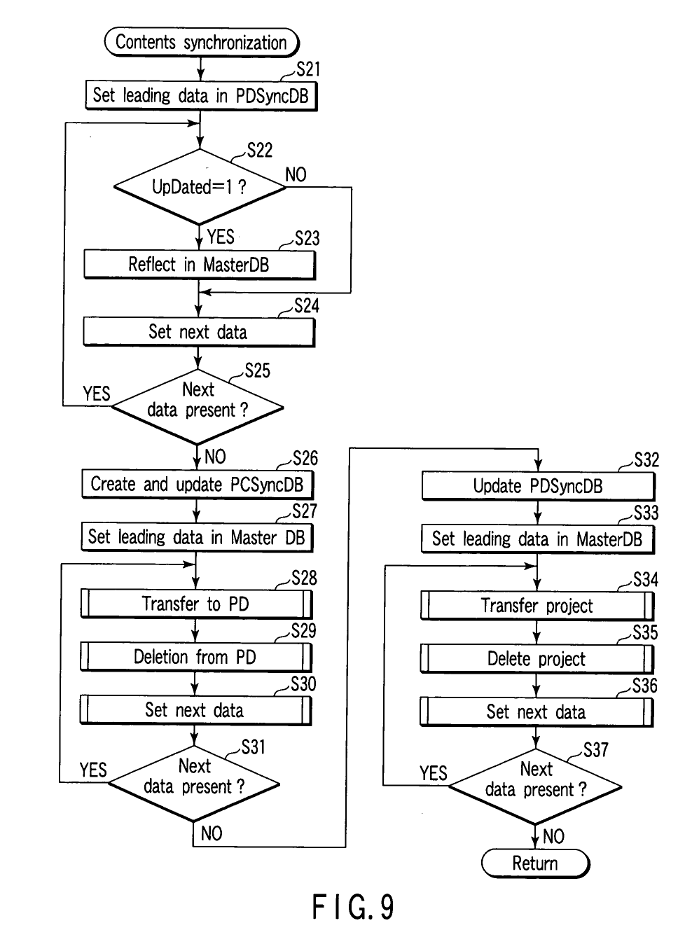

Now, the content synchronizing process (step S8 in FIG. 6) will be described with reference to the flowchart in FIG. 9.

First, the leading data in PDSyncDB in PD 2 is set to PC 1 (step S21). The system determines whether or not 1 is set in the update (UpDated) flag set in the third bit of a control flag (CtrlFlag) in the leading data (step S22). If the system determines that the update flag is set to “1” (YES), the system determines that the content have been updated. The content of the update are then reflected in MasterDB 103C (step S23). After the reflection or if the system does not determine in step S22 that the update flag is set (NO), the next data is read from PDSyncDB 215B and is set (step S24). The system determines whether or not the next data is present (step S25). If the next data is set (YES), the process returns to step S22 to execute an update process again. On the other hand, if the next data is not present (NO), the system determines that no reflecting process has been executed or that a reflecting process has been executed on all the data. Then, a process of creating and updating PCSyncDB 103B is executed (step S26). That is, on the basis of SynchronizationTBL in MasterDB 103C, DB with F_Sync=1 and F_UnSync=0 or with F_Sync=0 and F_Delete=1 is created. If PCSyncDB is already present, an overwrite process is also executed. Besides the creating process, a write process is executed on the content files used for the project.

Then, the leading data in MasterDB 103C is set (step S27). As described below, a process of transfer to PD 2 is then executed in which the set data is transferred to PDSyncDB 215B in PD 2 (step S28). As described below, a process of deletion from PD 2 is executed in which the transferred data is set with unwanted obsolete data deleted (step S29). After the deletion process is finished, the next data in MasterDB 103C is set (step S30). Then, the system determines whether or not the next data is present (step S31). If the next data is present (YES), the process returns to step S28 to execute an update process. On the other hand, if the next data is not present (NO), the process of updating PDSyncDB 215B is completed (step S32).

Then, a process of updating the project file is executed. First, the leading data in MasterDB 103C is set (step S33). Subsequently, a project transfer process is executed as described below (step S34). A project deletion process is then executed (step S35). After the deletion, the next data is set (step S36). On this occasion, the system determines whether or not the next data is present (step S37). If the next data is present (YES), the process returns to step S34 to execute a project transfer process again. On the other hand, if the next data is not present (NO), the process returns.

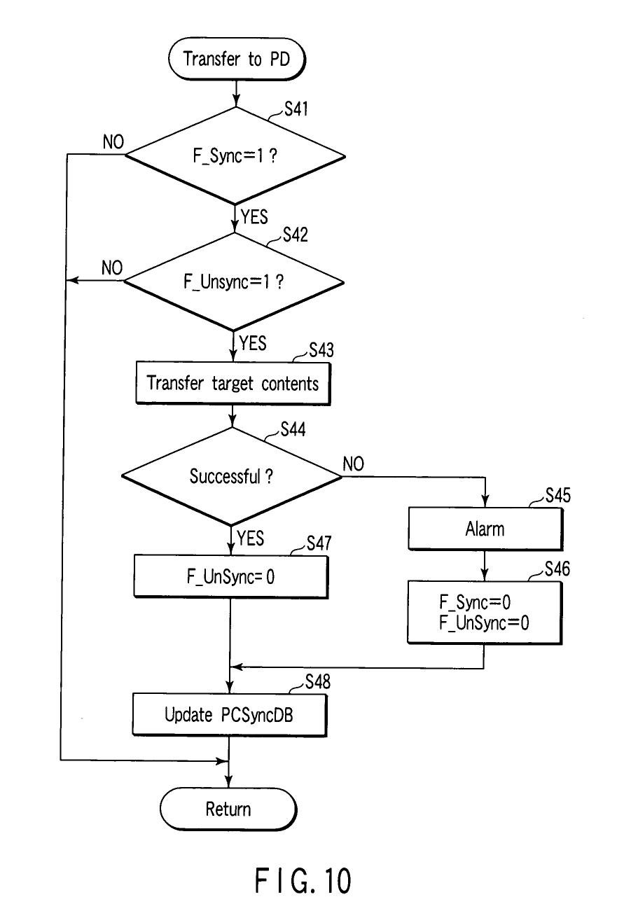

Now, with reference to the flowchart shown in FIG. 10, description will be given of the process of “transfer to PD” in step S28.

First, the system determines whether or not a flag of “1” is set so as to carry out synchronization (F_Sync=1?) (step S41). If the flag is set to “1”, that is, if the flag is set so as to carry out synchronization (YES), the system then determines whether or not the need for synchronization results from a new addition, an update in the content, or the like, that is, the system determines whether or not F_UnSync=1 (step S42), If the system determines that “1” is set in the F_Unsync flag, the target content are transferred (step S43). That is, unsynchronized files are transferred (copied).

On the other hand, if “1” is not set in the flag in each of steps S41 and S42, the system does not determine that the flag is set so as to carry out synchronization or that synchronization needs to be carried out.

The system then determines whether the target content have been successfully transferred (step S44). If the system does not determine that the transfer can be executed (NO), the monitor 12 or speaker 13 of PC 1 may provide an alarm display or an alarm sound, respectively. Further, depending on the communication configuration, PD 2 may issue an alarm. After the alarm, to avoid a subsequent synchronizing process unless a certain action is taken, these flags are set to “0”, that is, F_Sync=0 and F_UnSync=0 are set (step S46). On the other hand, if the system determines in step S44 that the target content have been successfully transferred (YES), F_UnSync=0 is set (step S47). PCSyncDB is updated (step S48) and the process returns.

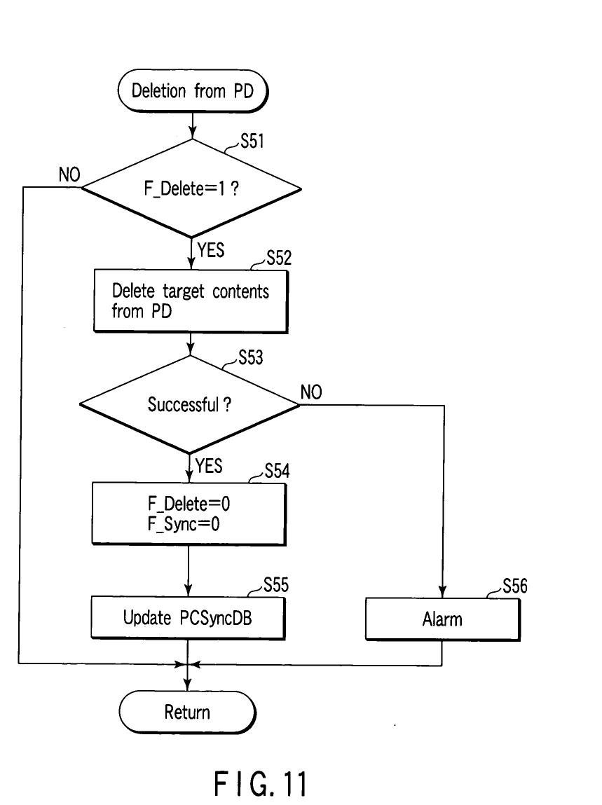

Now, with reference to the flowchart in FIG. 11, description will be given of the process of “deletion from PD 2” in step S29.

The system determines whether or not the user has set the asset deletion flag F_Delete=1 (step S51). If the system determines that “1” is set in the flag (YES), the target content are deleted from PD 2 (step S52). On the other hand, if “1” is not set in the deletion flag, the process shifts to step S56, described below.

Then, the system determines whether or not the deletion process in step S52 has been successful (step S53). If the deletion has been successful (YES), each flag is set to “0”, that is, F_Delete=0 and F_UnSync=0 are set (step S54). Since the deletion has been completed, PCSyncDB 103B is updated (step S55) and the process returns.

If the system does not determine in step S52 that the deletion process has been successful (NO), an alarm is issued (step S56) and the process returns. Further, if the system does not determine in step S51 that the asset deletion flag is set (F_Delete=0)(NO), the process also returns.

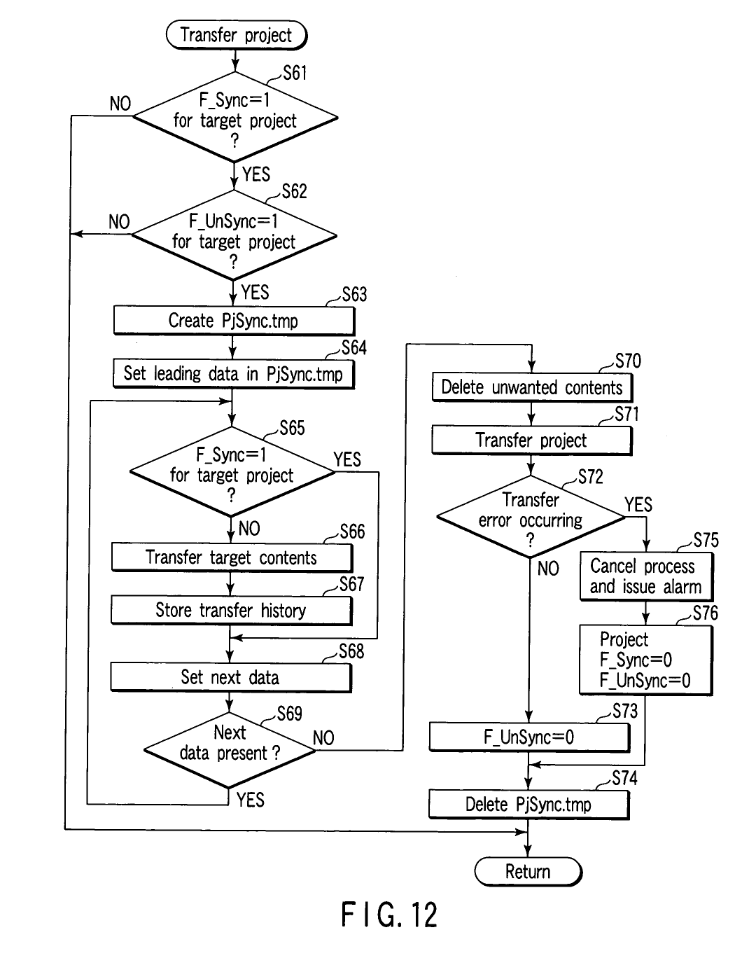

Now, with reference to the flowchart shown in FIG. 12, description will be given of the “project transfer” process in step S34.

First, the system determines whether or not the setting is made so as to execute synchronization on the target project file, that is, whether or not the synchronization flag F_Sync=1 (step S61). If the system determines that “1” is set in the synchronization flag F_Sync (YES), then the system determines whether or not the nonsynchronization flag F_UnSync=1 (step S62). That is, the system then determines whether or not the need for synchronization results from a new addition, an update in the content, or the like. If the system determines that the unsynchronization F_UnSync is set to “1” (YES), PjSync.tmp is created (step S63). PjSync.tmp is a list of content used for one project file. On the other hand, if the system determines in steps S61 and S62 that the flag is set to “0”, that is, if the system determines that F_Sync=0 or F_UnSync=0 (NO), the process returns.

Then, to transfer the target project file (content), the leading data in the created PjSync.tmp is set (step S64). The system determines whether or not the content shown in PjSync.tmp have been transferred (step S65). Whether or not the content have been transferred is determined by checking the set states of the F_Sync and F_UnSync flags for the target content, and if any project file is already present, comparing the target content with the content of the already present project file when the transfer corresponds to an “update”.

If the system does not determine that the target content in the project file have been transferred (NO), then the target content are transferred (step S66) and a transfer history is stored. For example, whether or not the transfer has been successful is stored (step S67). After the storage, the next data is set (step S68). On the other hand, if the system determines in step S65 that the target content have already been transferred (YES), the process shifts to step S68 to set the next data. The system then determines whether or not the set next data is present (step S69). If the system determines that the next data is present (YES), the process returns to step S65 to check whether or not the content have been transferred. On the other hand, if the next data is not present (NO), unwanted content are deleted (step S70). The deletion process is executed by using any of various methods, for example, setting the condition that the content are used in an obsolete project file, that the content have not been used yet, or that F_Sync=0 and removing the content meeting the condition from PD 2.

Then, the project file is transferred (step S71). Subsequently, the system determines whether or not an error has occurred in the transfer of the project file and target content (step S72). If the project file and target content have been correctly transferred without any transfer errors (NO), the flag F_UnSync=0 is set to indicate that the synchronizing process has been completed (step S73). Subsequently, since the target project file has been completely transferred, PjSync.tmp, created in step S63, is deleted (step S74). The process then returns.

On the other hand, if the system determines in step S72 that a transfer error is occurring (YES), the transfer process is canceled (step S75). Further, the flags F_Sync=0 and F_UnSync=0 are set for the project file in which the transfer error is occurring, to prevent the project file from being subsequently transferred (step S76). The process then returns.

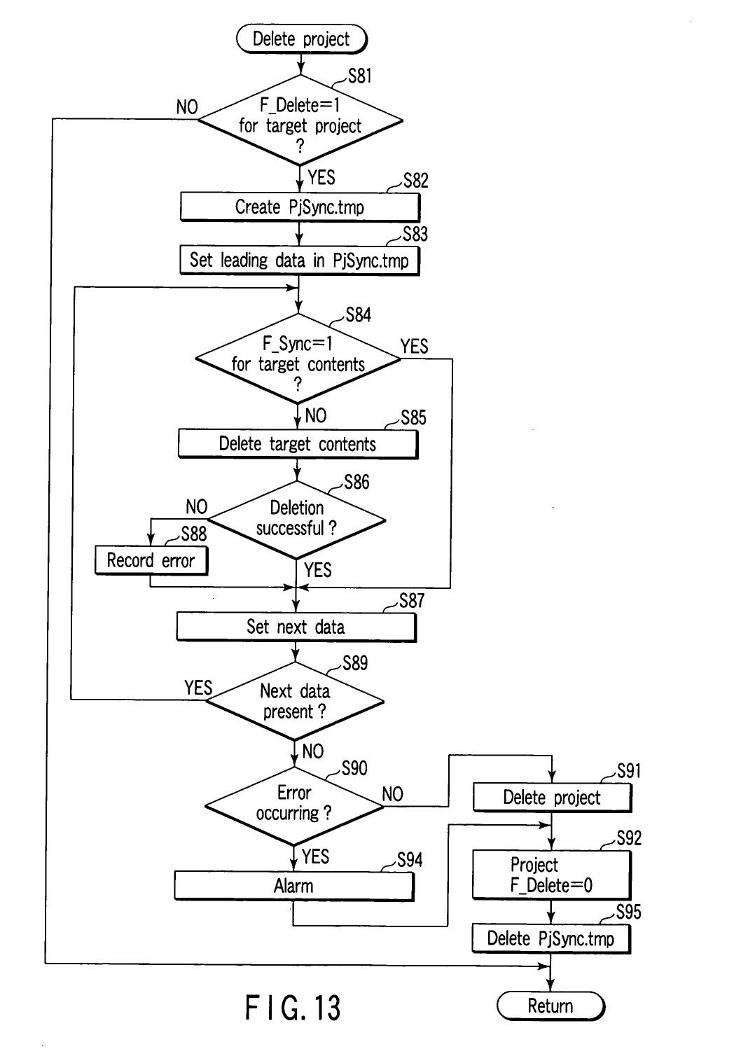

Now, with reference to the flowchart in FIG. 13, description will be given of the “project deletion” process in step S35.

First, the system determines whether or not the deletion flag F_Delete=1 is set for the target project file (step S81). If the system does not determine that “1” is set in the flag (NO), the process returns. If “1” is set in the deletion flag (YES), PjSync.tmp is created (step S82). PjSync.tmp is a list of content used for one target project file (extracted from the project files stored in PD 2).

Subsequently, to delete the target project file (content), the leading data in the created PjSync.tmp is set (step S83). The system determines whether or not the synchronization flag F_Sync=1 is set for the target content shown in PjSync.tmp (step S84). If the system does not determine that the synchronization flag is set to “1” (NO), the target content are deleted (step S85).

Then, the system determines whether or not the transferred target content have been successfully deleted (step S86). If the system determines that the transferred target content have been successfully deleted (YES), the next data is set (step S87). On the other hand, if the target content have not been successfully deleted (NO), the deletion error is recorded. The process then shifts to step S87. Further, if the system determines in step S84 that the synchronization flag F_Sync is set to “1” (YES), the process shifts to step S87.

The, the system determines whether or not the next data (content) was set in step S87 (step S89). If the next data is present (YES), the process returns to step S84 to check the synchronization flag for the target content. On the other hand, if the next data is not present (NO), the system determines that all the target content have been deleted.

Then, the system determines whether or not a deletion error was stored in step S88 (step S90). If the system determines that no deletion error has occurred (NO), the project file is deleted (step S91). The deletion flag F_Delete=0 is set for the project file (step S92). Further, if the system determines in step S90 that a deletion error has occurred (YES), an alarm is issued (step S93). The process then shifts to step S92.

After the deletion flag has been set, PjSync.tmp for the created project file is deleted (step S95). The process then returns.

As described-above, the information processing system in accordance with the present embodiment can carry out synchronization by extracting music data, image data, and template data used in a project file, determining whether or not the data has been transferred to or updated for PD capable of executing a synchronizing process, and transferring required data or the like depending on the determination.

Consequently, the synchronizing process is executed by transferring only the required data. Only the required data is stored in PD, thus avoiding storing useless data in the hard disk (memory). This prevents the storage capacity from being wastefully reduced.

The present invention provides an information processing system that appropriately synchronizes content files when transferring content data between external equipment that supplies music data or image data and a portable device.

In the present embodiment, if synchronization is set in the project file, the existing project is compared with the contents used in the project file in step S65 in order to determine whether or not the contents have already been transferred. However, the present invention is not limited to this. For example, if, for example, synchronization is set in the project file or the project file with synchronization set has been updated or deleted, F_Sync may be re-set for all the material contents used in the project file. That is, if synchronization of the project file is turned on, F_Sync is set to “1” for all the contents used in the project file (ON). However, in this case, if the synchronization of the project file is then turned off, F_Sync is not set to “0” for the contents used in the project file (OFF). Further, if the project file with synchronization turned on has been updated, F_Sync is set to “1” for contents added as a result of the update. In this case, F_Sync is not set to “0” for contents having become useless as a result of the update as in the above case.

Additional advantages and modifications will readily occur to those skilled in the art. Therefore, the invention in its broader aspects is not limited to the specific details and representative embodiments shown and described herein. Accordingly, various modifications may be made without departing from the spirit or scope of the general inventive concept as defined by the appended claims and their equivalents.

What is claimed is:

1. An information processing system which synchronizes plural types of content data stored in each of an information processing apparatus and a portable terminal, the system comprising:
first synchronizing means for executing a synchronizing process on independently reproduced first content data;
second synchronizing means for executing a synchronizing process on second content data reproduced with reference to other material content; and
third synchronizing means for executing a synchronizing process on the material content.

2. The information processing system according to claim 1, wherein the material content data is music content data.

3. The information processing system according to claim 1, wherein the material content data is image data.

4. The information processing system according to claim 1, wherein the material content are part of the first content data.

5. The information processing system according to claim 2, wherein the third synchronizing means executes a synchronizing process if the second content data has been created.

6. The information processing system according to claim 2, wherein the third synchronizing means executes a synchronizing process if the second content data has been updated.

7. The information processing system according to claim 2, wherein the third synchronizing means executes a synchronizing process if the second content data has been created and updated.

8. The information processing system according to claim 3, wherein the third synchronizing means executes a synchronizing process if the second content data has been created.

9. The information processing system according to claim 3, wherein the third synchronizing means executes a synchronizing process if the second content data has been updated.

10. The information processing system according to claim 3, wherein the third synchronizing means executes a synchronizing process if the second content data has been created and updated.

11. The information processing system according to claim 1, further comprising selecting means for allowing a user to select which content data is to be subjected to a synchronizing process by the first synchronizing means.

12. The information processing system according to claim 1, further comprising selecting means for allowing a user to select which content data is to be subjected to a synchronizing process by the second synchronizing means.

13. The information processing system according to claim 1, further comprising selecting means for allowing a user to select which content data is to be subjected to a synchronizing process by the first synchronizing means and the second synchronizing means.

14. The information processing system according to claim 11, wherein when executing a synchronizing process if the second content data has been updated, the third synchronizing means deletes from the portable terminal material content data which are referenced in the second content data prior to the update and which are not referenced in the updated second content data, the material content data not having been selected to be subjected to a synchronizing process by the first synchronizing means.

15. The information processing system according to claim 12, wherein when executing a synchronizing process if the second content data has been updated, the third synchronizing means deletes from the portable terminal material content data which are referenced in the second content data prior to the update and which are not referenced in the updated second content data, the material content data not having been selected to be subjected to a synchronizing process by the first synchronizing means.

16. The information processing system according to claim 13, wherein when executing a synchronizing process if the second content data has been updated, the third synchronizing means deletes from the portable terminal material content data which are referenced in the second content data prior to the update and which are not referenced in the updated second content data, the material content data not having been selected to be subjected to a synchronizing process by the first synchronizing means.

17. The information processing system according to claim 1, wherein the third synchronizing means transfers the material content stored in the portable terminal from the information processing apparatus to the portable terminal.

18. The information processing system according to claim 1, wherein the other material content are the first content used by the second content.
